(19) United States
(12) Patent Application Publication
(10) Pub. No.: US 2008/0236947 A1
(43) Pub. Date: Oct. 2, 2008

(54) ASSEMBLABLE LADDER

(76) Inventor: Chen-Hsiung Lin, Lutsao Hsiang (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/691,979

(22) Filed: Mar. 27, 2007

(51) Int. Cl. E06C 1/00

(52) U.S. Cl. 182/165

(57) ABSTRACT

An assemblable ladder comprises two upright first and second supports, and side plates, mounting members, and screwing elements severing to couple the two first supports together, and to connect the two second supports together. By using a cover piece and other screwing elements, the two coupled first supports and the two connected second supports are assembled together. By way of other screwing elements, pedals are attached between the parallel first and second supports, and connection members are disposed between the pedals and one of the two first supports, or between the pedals and one of the two second supports. Besides, fastening pieces are secured between another parallel first and second supports, and other connection members are fixed between the fastening pieces and the other of the two first supports, or between the fastening pieces and the other of the two second supports, thereby easily assembling the ladder in a DIY manner.

### BACKGROUND OF THE INVENTION

1. Field of the Invention

The present invention relates to an assemblable ladder that is used by general customers or professional workers on decorating, painting, or lamp maintaining conditions, especially in a high place, likewise, the manufacturers can pack it in the smallest size after production of the related parts thereof, thus allowing it to be conveniently portable, and to be easily assembled in a DIY manner by customers.

2. Description of the Prior Arts

There are many types of prior art ladders, for example, as shown in FIGS. 11-13, a conventional ladder 50 made from aluminum, includes a plurality of pedals 30 individually disposed between two parallel supports 20, at the top of two pivotally connected supports 20 being secured a hinge 40 for freely extending or retracting the ladder 50. In addition, by using a riveting method, the pedals 30 are defined between two parallel supports 20, and two ends thereof inserts through two parallel supports 20 respectively, such that each of the pedals 30 between two parallel supports 20 can be fixed, thereby achieving the ladder 50.

Nevertheless, such a ladder and its supports are not solid, since each of the pedals thereof is defined between two parallel supports by riveting, and two ends thereof insert through two parallel supports, respectively.

The present invention has arisen to mitigate and/or obviate the afore-described disadvantages.

### SUMMARY OF THE INVENTION

The primary objective of the present invention is to provide an assemblable ladder comprises two first and second supports, two side plates, each for coupling the respective first and second supports together, two mounting members, each abutting against the respective side plates, a cover piece fastened to the tops of the two connected first and second supports, pedals coupled to and between the inner sides of the parallel first and second supports, fastening pieces connected to and between the inner sides of another parallel first and second supports, and screwing elements for assembling above-mentioned components of the ladder together. While in assembly, the user has to upright two first and second supports, and then to apply the side plates, the mounting members and the screwing elements to couple the two first supports together, and to connect the two second supports together. Thereafter, by way of a cover piece and other screwing elements, the two coupled first supports and the two connected second supports are assembled together. Further, by means of other screwing elements, the pedals are attached between the parallel first and second supports, and connection members are disposed between the pedals and one of the two first supports, or between the pedals and one of the two second supports. Besides, the fastening pieces are secured between another parallel first and second supports, and other connection members are fixed between the fastening pieces and the other of the two first supports, or between the fastening pieces and the other of the two second supports, thereby easily assembling the ladder in a DIY manner.

The present invention will become more obvious from the following description when taken in connection with the accompanying drawings, which show, for purpose of illustrations only, the preferred embodiment in accordance with the present invention.

### BRIEF DESCRIPTION OF THE DRAWINGS

FIG. 1 is an exploded view of showing an assemblable ladder in accordance with the present invention;

FIG. 2 is an enlarged view of part A of FIG. 1;

FIG. 3 shows two coupled first and second supports being about to be assembled together by using a cover piece and screwing elements, and pedals being about to be attached between the parallel first and second supports, by means of other screwing elements;

FIG. 4 is an enlarged view of part B of FIG. 3;

FIG. 5 is an enlarged view of e part C of FIG. 3;

FIG. 6 is a perspective view of the assemblable ladder in accordance with the present invention;

FIG. 7 is an assembly cross-sectional side view of the cover piece and the two coupled first supports of the present invention;

FIG. 8 is an assembly cross-sectional top plan view of the cover piece and the two first and second supports of the present invention;

FIG. 9 is an assembly cross-sectional top plan view of the pedals and the parallel first and second supports of the present invention;

FIG. 10 shows the assemblable ladder of the present invention being retracted;

FIG. 11 is a perspective view of a conventional ladder;

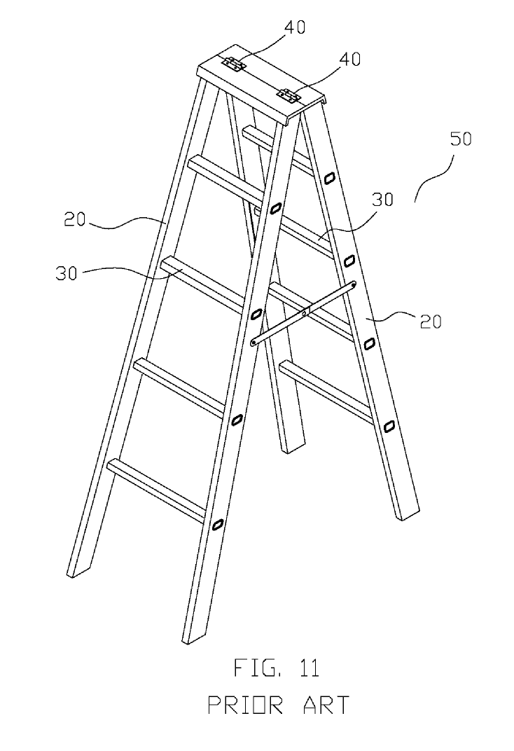

FIG. 12 is a partial assembly view of the respective pedals and supports of the conventional ladder;

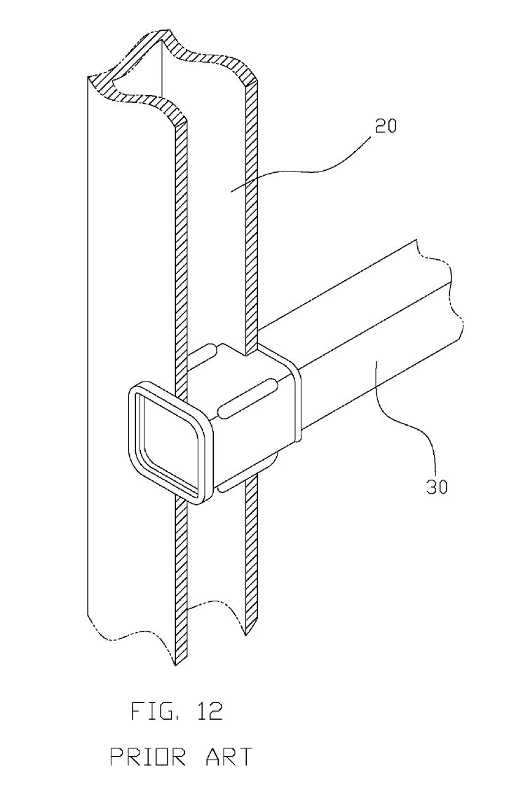

FIG. 13 is a partial assembly cross-sectional view of the respective pedals and supports of the conventional ladder.

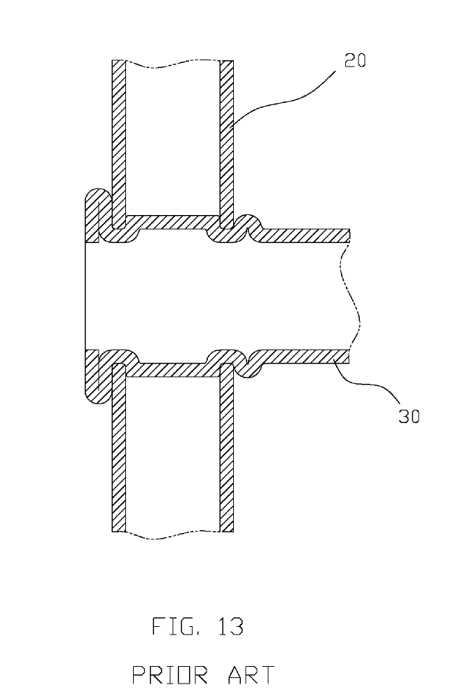

### DETAILED DESCRIPTION OF THE PREFERRED EMBODIMENT

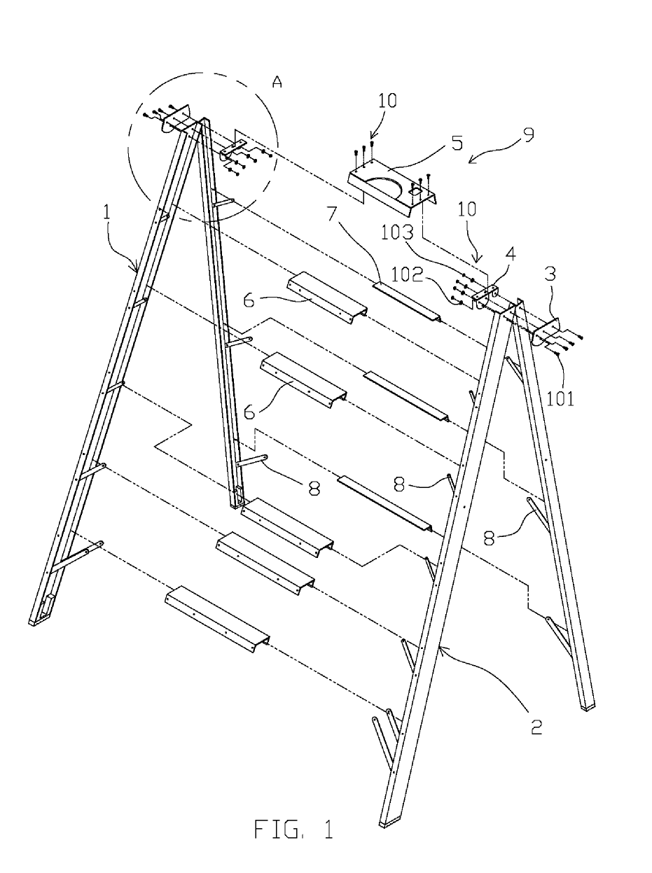

Referring to FIGS. 1-3, an assemblable ladder comprises two upright first and second supports 1 and 2, and side plates 3, mounting members 4, screwing elements 10 severing to couple the two first supports 1 together, and to connect the two second supports 2 together. By using a cover piece 5 and other screwing elements 10, the two coupled first supports 1 and the two connected second supports 2 are assembled together. By way of other screwing elements 10, pedals 6 are attached between the parallel first and second supports 1 and 2, and connection members 8 are disposed between the pedals 6 and one of the two first supports 1, or between the pedals 6 and one of the two second supports 2. Besides, fastening pieces 7 are secured between another parallel first and second supports 1 and 2, and other connection members 8 are fixed between the fastening pieces 7 and the other of the two first supports 1, or between the fastening pieces 7 and the other of the two second supports 2, thereby easily assembling a ladder 9 in a DIY manner.

After production of the related parts of the ladder 9, the manufacturer is allowed to pack the ladder 9 in the smallest size so that it can be conveniently portable and easily assembled in a DIY manner by the customer. While in assembly, the customer has to in turn assemble the related components of the ladder 9 together depended on the following steps:

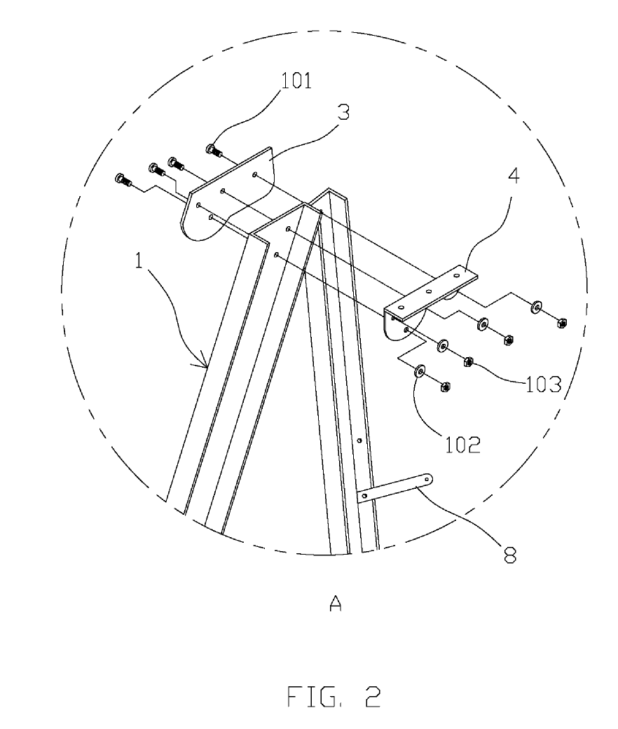

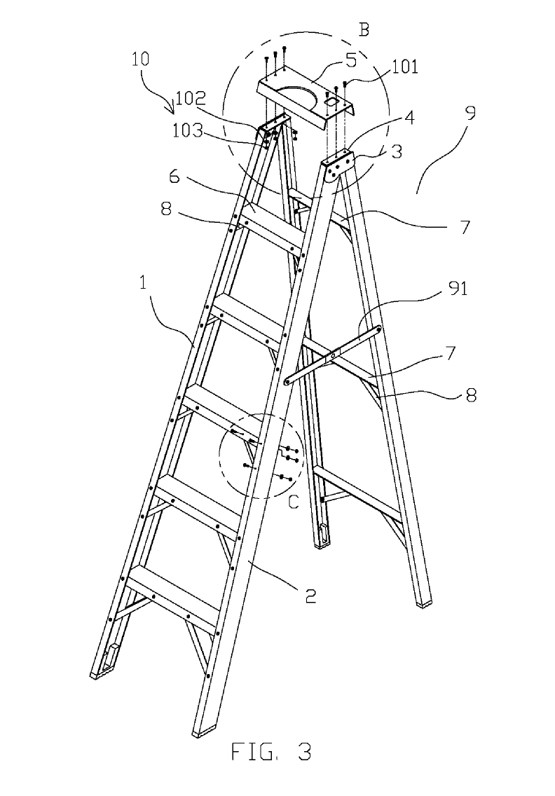

As shown in FIGS. 1 and 2, uprighting the two first supports 1, and coupling them with each other. By retaining a side plate 3 and a mounting member 4 together, and as shown in FIG. 3, by using screwing elements 10 including screws 101, washers 102 and nuts 103, the two coupled first supports 1, the side plate 3 and the mounting member 4 are temporarily coupled together, while the nuts 103 have not yet to be matingly mounted to the screws 104. The same method as mentioned above is utilized to the connection of the two second support 2, another side plate 3 and another mounting member 4 as well.

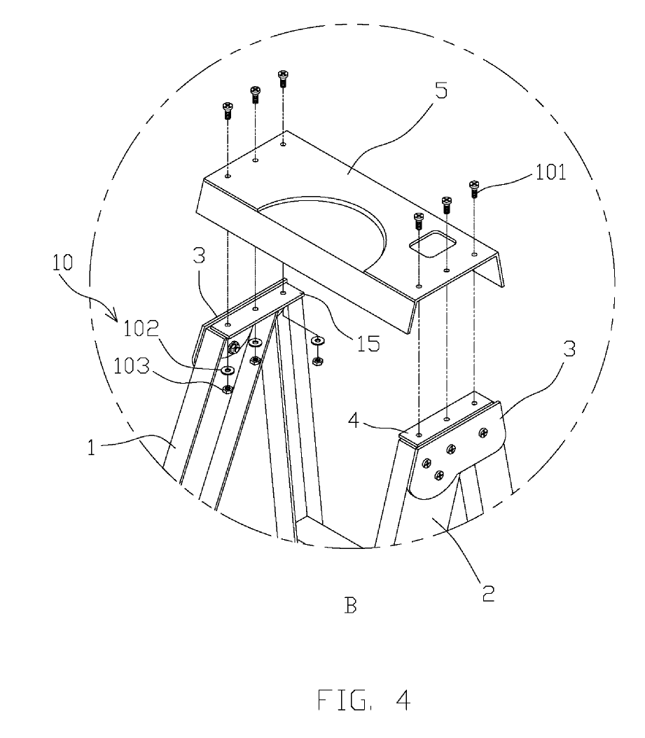

With reference to FIGS. 3, 4 and 6, placing the cover piece 5 on the tops of the two coupled first and second supports 1, 2, and by virtue of other screwing elements 10 including screws 101, washers 102 and nuts 103, the cover piece 5, the two coupled first supports 1 and the two connected second supports 2 are temporarily joined together, while the nuts 103 have not yet to be securely mounted to the screws 104.

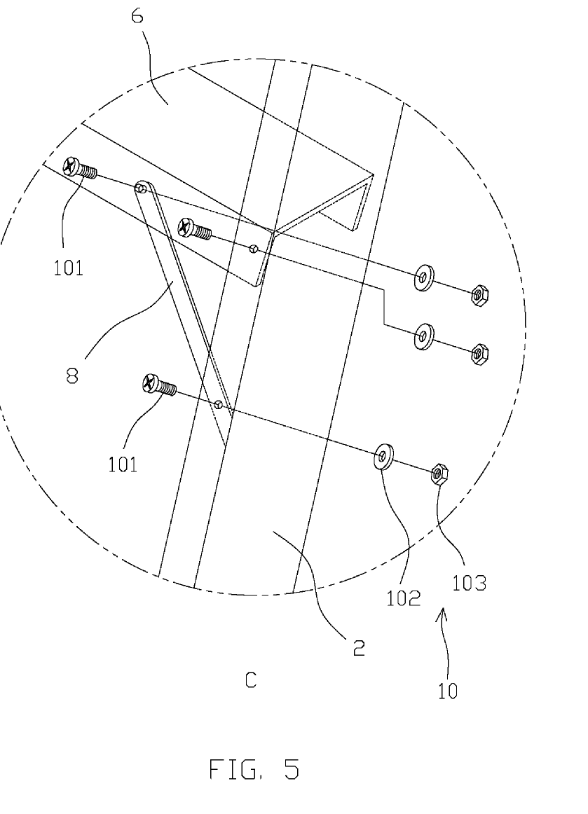

Referring further to FIGS. 3, 5 and 6, the pedals 6 and the connection members 8 at two sides of the pedals 6 are in turn adjacent to the inner sides of the parallel first and second supports 1 and 2. And by means of other screwing elements 10 including screws 101, washers 102 and nuts 103, the pedals 6, the connection members 8 and the parallel first and second supports 1, 2 are temporarily connected together, while the nuts 103 have not yet to be matingly screwed to the screws 104.

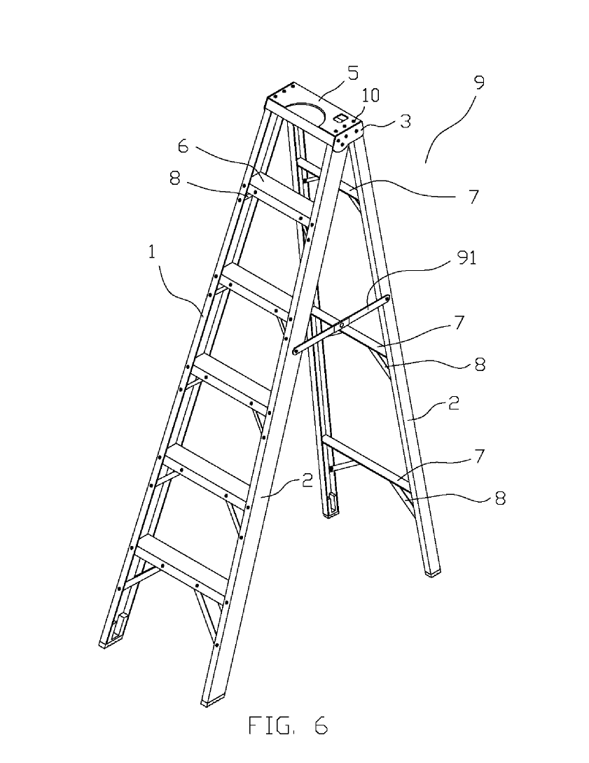

Referring further to FIGS. 1 and 6, the fastening pieces 7 and other connection members 8 at two sides of the fastening pieces 7 are abutted against the inner sides of another parallel first and second supports 1 and 2, and by using of other screwing elements 10 including screws 101, washers 102 and nuts 103, the fastening pieces 7, other connection members 8 and another parallel first and second supports 1, 2 are temporarily connected together, while the nuts 103 have not yet to be securely screwed to the screws 104.

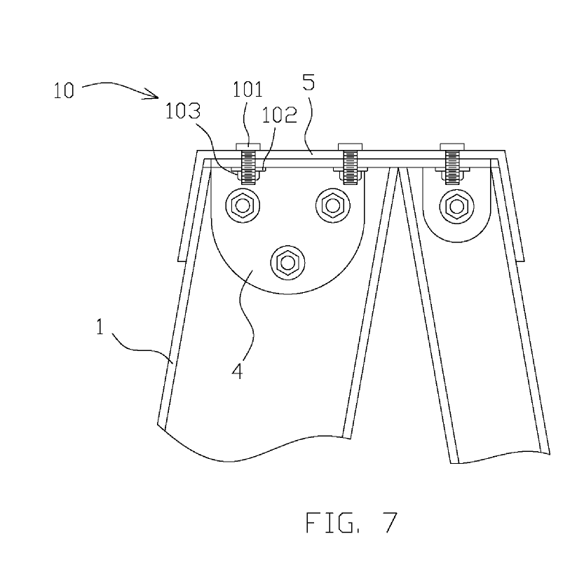

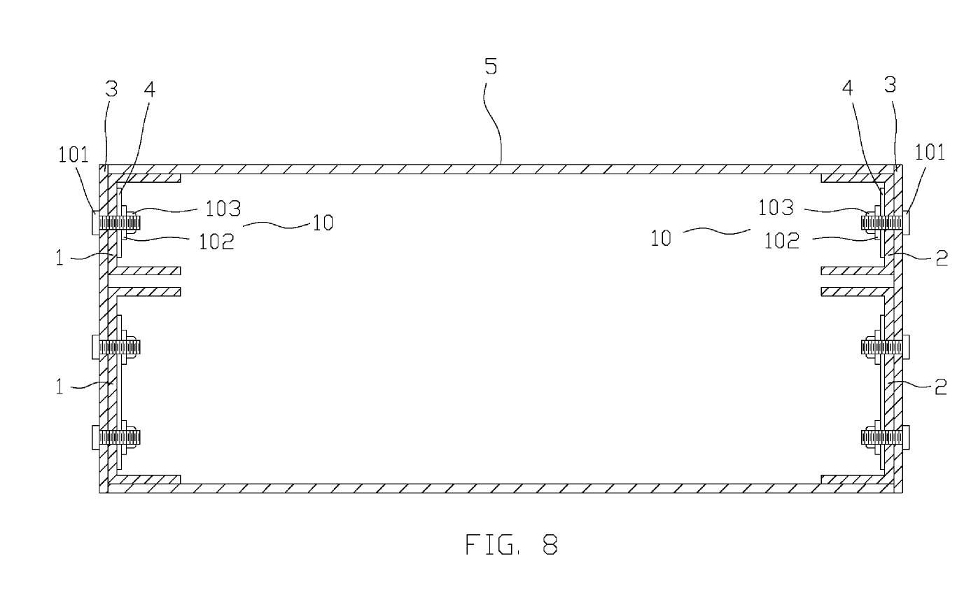

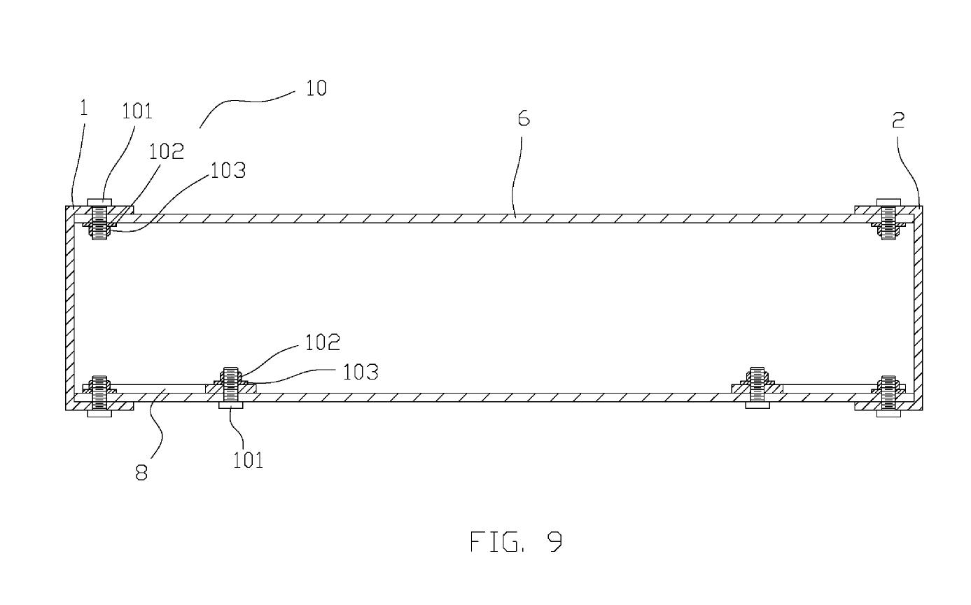

Referring to the FIG. 7, matingly screwing the screwing elements 10 to and between the cover piece 5 and the coupled first supports 1. The same method as mentioned above is utilized to the cover piece 5 and the connected second supports 2 (not shown). As shown in FIG. 8, mounting the screwing elements 10 to the tops of the two connected first and second supports 1 and 2, and to and between the side plates 3 and the mounting members 4, the mounted screwing elements 10 are adjustably fastened or loosened based on the expanding or retracting status of the connecting joints of the first and second supports 1 and 2. Referring to FIG. 9, fastening the screw elements 10 to and between the pedals 6 and the connection members 8, simultaneously, matingly fixing the screw elements 10 to and between the pedals 6 and the fastening pieces 7 (not shown), thereby easily assembling the ladder 9 in a DIY manner.

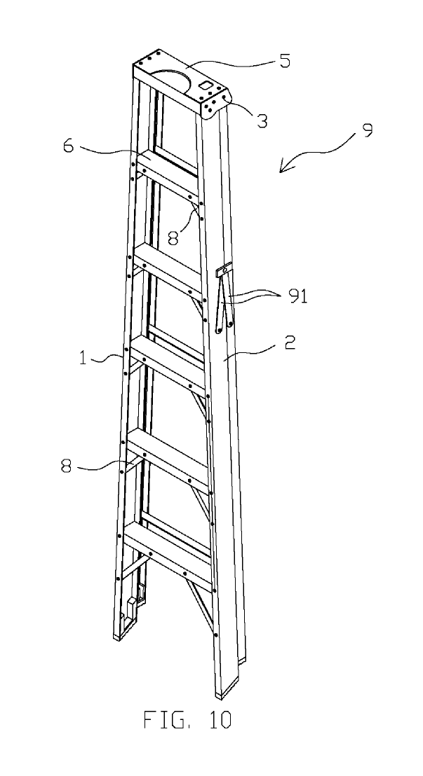

With reference to FIG. 10, while the ladder 9 is not in use, by way of folding members 91 disposed onto predetermined pivotally joining positions of the first and second supports 1 and 2, the ladder 9 can be retracted for the convenient storage thereof.

It is concluded from the above-mentioned structure and steps that the ladder of the present invention contains the following advantages:

First, after production of the related parts of the ladder, the manufacturer is allowed to pack the ladder in the smallest size so that it can be conveniently portable and easily assembled in a DIY manner by the customer.

Second, while in assembly, the user merely has to upright two first and second supports, and then to apply the side plates, the mounting members and screwing elements to couple the two first supports together, and to connect the two second supports together. Thereafter, by way of a cover piece and other screwing elements, the two coupled first supports and the two connected second supports are assembled together. Further, by means of other screwing elements, the pedals are attached between the parallel first and second supports, and connection members are disposed between the pedals and one of the first supports, or between the pedals and one of the two second supports. Besides, the fastening pieces are secured between another parallel first and second supports, and other connection members are fixed between the fastening pieces and the other of the two first supports, or between the fastening pieces and the other of the two second supports, thereby easily assembling the ladder in a DIY manner, and achieving a stable support purpose thereof.

Third, the ladder of the present invention is allowed to be assembled or disassembled in accordance with different conditions, for example, if it is stored in a car, its related components can be disassembled so as to be conveniently portable and stored therein.

While we have shown and described various embodiments in accordance with the present invention, it should be clear to those skilled in the art that further embodiments may be made without departing from the scope of the present invention.

What is claimed is:

1. An assemblable ladder comprising:
two upright first and second supports, and side plates, mounting members, and screwing elements severing to couple said two first supports together, and to connect said two second supports together, by using a cover piece and other screwing elements, the two coupled first supports and the two connected second supports being assembled together, by way of other screwing elements, pedals being attached between the parallel first and second supports, and connection members being disposed between said pedals and one of said two first supports, or between said pedals and one of said two second supports, besides, fastening pieces being secured between another parallel first and second supports, and other connection members being fixed between said fastening pieces and the other of said two first supports, or between said fastening pieces and the other of said two second supports, thereby easily assembling said ladder in a DIY manner.
